(19) United States
(12) Patent Application Publication
(10) Pub. No.: US 2025/0181910 A1
(43) Pub. Date: Jun. 5, 2025

(54) OVERCOMING MAXIMUM TOKEN LIMITATIONS OF LARGE LANGUAGE MODELS

(71) Applicant: INTERNATIONAL BUSINESS MACHINES CORPORATION, ARMONK, NY (US)

(72) Inventors: Zhong Fang Yuan, Xi'an (CN); Li Juan Gao, Xi'an (CN); Tong Liu, Xi'an (CN); Yuan Yuan Ding, Shanghai (CN)

(21) Appl. No.: 18/526,373

(22) Filed: Dec. 1, 2023

(51) Int. Cl. G06N 3/08; G06N 3/04

(52) U.S. Cl. CPC G06N 3/08; G06N 3/04

(57) ABSTRACT

An embodiment for overcoming maximum token limitations in large language models. The embodiment may receive a target text. The embodiment may split an attention matrix associated with the target text into a series of sub-matrices. The embodiment may leverage a gated recurrent unit neural network to encode fixed-length vectors corresponding to the series of sub-matrices. The embodiment may construct a directed acyclic graph in which the encoded fixed-length vectors are nodes and wherein connections between the nodes are defined based on a target task. The embodiment may leverage a graph neural network to perform dynamic graph construction and node feature transfers to iteratively generate an updated graph including a series of most relevant node features and connection relationships. The embodiment may generate one or more summaries for the received target text by extracting information from the updated graph.

### BACKGROUND

The present application relates generally to computer processing, and more particularly, to overcoming maximum token limitations in large language models.

Large language models are becoming increasingly prevalent due to their ability to understand and generate human-like text. Many businesses area actively investing in discovering and taking advantage of opportunities to leverage large language models for a variety of end-uses designed to increase efficiency and competitiveness. For example, businesses may leverage large language models to automate tasks, gain insights, improve customer experiences, generate content, and much more. Accordingly, large language models which have increased flexibility and utility are highly desirable.

### SUMMARY

According to one embodiment, a method, computer system, and computer program product for overcoming maximum token limitations in large language models is provided. The embodiment may include receiving a target text. The embodiment may also include splitting an attention matrix associated with the target text into a series of sub-matrices. The embodiment may further include leveraging a Gated Recurrent Unit (GRU) neural network to encode fixed-length vectors corresponding to the series of sub-matrices. The embodiment may also include constructing a directed acyclic graph in which the encoded fixed-length vectors comprise nodes and wherein connections between the nodes are defined based on a target task. The embodiment may further include leveraging a graph neural network (GNN) to perform dynamic graph construction and node feature transfers to iteratively generate an updated graph including a series of most relevant node features and connection relationships. The embodiment may also include generating one or more summaries for the received target text by extracting information from the updated graph.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of overcoming maximum token limitations in large language models according to at least one embodiment; and

FIG. 3 illustrates an exemplary process of splitting an attention matrix associated with a received target text into a series of sub-matrices according to at least one embodiment;

FIG. 4 illustrates an exemplary process of constructing directed acyclic graphs according to at least one embodiment; and

FIG. 5 depicts an illustrative process of leveraging a graph neural network (GNN) to perform dynamic graph construction and node feature transfers to iteratively generate an updated graph including a series of most relevant node features and connection relationships according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computer processing, and more particularly, to overcoming maximum token limitations in large language models. The following described exemplary embodiments provide a system, method, and program product to, among other things, receive a target text, split an attention matrix associated with the target text into a series of sub-matrices, leverage a gated recurrent unit neural network to encode fixed-length vectors corresponding to the series of sub-matrices, construct a directed acyclic graph in which the encoded fixed-length vectors comprise nodes and wherein connections between the nodes are defined based on a target task, leverage a graph neural network to perform dynamic graph construction and node feature transfers to iteratively generate an updated graph including a series of most relevant node features and connection relationships, and generate one or more summaries for the received target text by extracting information from the updated graph.

As previously described, large language models (LLMs) are becoming increasingly prevalent due to their ability to understand and generate human-like text. Many businesses area actively investing in discovering and taking advantage of opportunities to leverage large language models for a variety of end-uses designed to increase efficiency and competitiveness. For example, businesses may leverage large language models to automate tasks, gain insights, improve customer experiences, generate content, and much more. Accordingly, large language models which have increased flexibility and utility are highly desirable.

However, there are several challenges and limitations with respect to utilizing large language models. For example, many large language models have undesirable limitations relating to maximum token limits that are processable by a given large language model. For example, an exemplary large language model may only be able to process a token sequence that is less than or equal to 32,000 tokens in length. If a given large language model receives a text that includes a token sequence exceeding the maximum token limit associated with the given large language model, then this may cause any text after the token limit to be discarded, thereby resulting in information loss. Recently proposed methods of addressing maximum token limits typically involve shortening received ‘long texts’ (texts exceeding a given maximum token limit) by combining retrieval or summarization techniques. However, because these methods do not directly handle the received long texts, they are often unable to perform fine-grained reading comprehension. Additionally, proposed methods often require consideration during the training phase and cannot be readily applied to existing LLM models. Thus, improved methods of overcoming maximum token limits for large language models which avoid these described shortcomings would be advantageous for businesses seeking to employ LLMs having increased model flexibility and utility.

Accordingly, a method, computer system, and computer program product for overcoming maximum token limitations in large language models is provided. The method, system, and computer program product may receive a target text. The method, system, computer program product may identify a defect in the printing operation based on the tracked print data. The method, system, computer program product may then split an attention matrix associated with the target text into a series of sub-matrices. The method, system, computer program product may leverage a gated recurrent unit neural network to encode fixed-length vectors corresponding to the series of sub-matrices. Next, the method, system, computer program product may construct a directed acyclic graph in which the encoded fixed-length vectors comprise nodes and wherein connections between the nodes are defined based on a target task. Then, the method, system, computer program product may leverage a graph neural network to perform dynamic graph construction and node feature transfers to iteratively generate an updated graph including a series of most relevant node features and connection relationships. Thereafter, the method, system, computer program product may generate one or more summaries for the received target text by extracting information from the updated graph. In turn, the method, system, computer program product has provided for improved methods of overcoming maximum token limits for large language models. Described embodiments functionally combine Naive Bayes methods with leveraging of gated recurrent unit neural networks as long-term memory storage to overcome the maximum token limit imposed by a given large language model. Presently described embodiments leverage gated recurrent unit neural networks to group encode subsequences of tokens in received target texts, enabling the calculation of attention matrices, and subsequent transformation of the grouped calculation units into a directed acyclic graph (DAG) using a Naive Bayes algorithm. In described embodiments, each node in the constructed DAG represents a computation unit, and whether each computation unit needs to be computed is dynamic, as opposed to previously proposed methods in which all units must be computed. The DAG decomposes the calculation process of the attention matrix into several parts, with each part corresponding to a node on the DAG. During the construction of the DAG, no computation units are executed, meaning that the computation of the DAG is essentially “lazy,” and each computation unit is only computed when it needs to be. In presently described embodiments, whether a computation node is computed or not depends on a probability relationship between a previous computed node and a given current node, which is also calculated using Naive Bayes methods. Thus, described embodiments overcome the limitations and challenges associated with previously described methods, and allow for summary generation (and performance of other tasks) for received ‘long texts’ which include token sequences exceeding a given maximum token limit for a given large language model.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

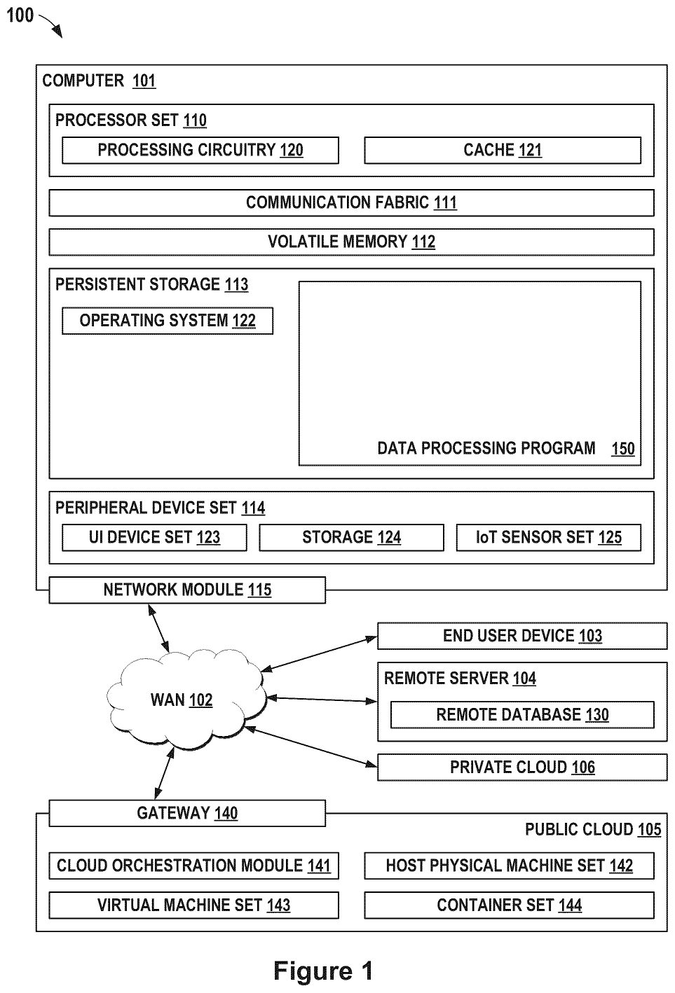

Referring now to FIG. 1, computing environment 100 contains an example of an environment for the execution of at least some of the computer code involved in performing the inventive methods, such as data processing program/code 150. In addition to data processing code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data processing code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data processing code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in data processing program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the data processing program 150 may be a program capable of receiving a target text. Data processing program 150 may then split an attention matrix associated with the target text into a series of sub-matrices. Next, data processing program 150 may leveraging a gated recurrent unit neural network to encode fixed-length vectors corresponding to the series of sub-matrices. Data processing program 150 may then construct a directed acyclic graph in which the encoded fixed-length vectors comprise nodes and wherein connections between the nodes are defined based on a target task. Next, data processing program 150 may leverage a graph neural network to perform dynamic graph construction and node feature transfers to iteratively generate an updated graph including a series of most relevant node features and connection relationships. Thereafter, data processing program 150 may generate one or more summaries for the received target text by extracting information from the updated graph. In turn, data processing program 150 has provided for improved methods of overcoming maximum token limits for large language models. Described embodiments functionally combine Naive Bayes methods with leveraging of gated recurrent unit neural networks as long-term memory storage to overcome the maximum token limit imposed by a given large language model. Presently described embodiments leverage gated recurrent unit neural networks to group encode subsequences of tokens in received target texts, enabling the calculation of attention matrices, and subsequent transformation of the grouped calculation units into a directed acyclic graph (DAG) using a Naïve Bayes algorithm. In described embodiments, each node in the constructed DAG represents a computation unit, and whether each computation unit needs to be computed is dynamic, as opposed to previously proposed methods in which all units must be computed. The DAG decomposes the calculation process of the attention matrix into several parts, with each part corresponding to a node on the DAG. During the construction of the DAG, no computation units are executed, meaning that the computation of the DAG is essentially “lazy,” and each computation unit is only computed when it needs to be. In presently described embodiments, whether a computation node is computed or not depends on a probability relationship between a previous computed node and a given current node, which is also calculated using Naive Bayes methods. Thus, described embodiments overcome the limitations and challenges associated with previously described methods, and allow for summary generation (and performance of other tasks) for received ‘long texts’ which include token sequences exceeding a given maximum token limit for a given large language model.

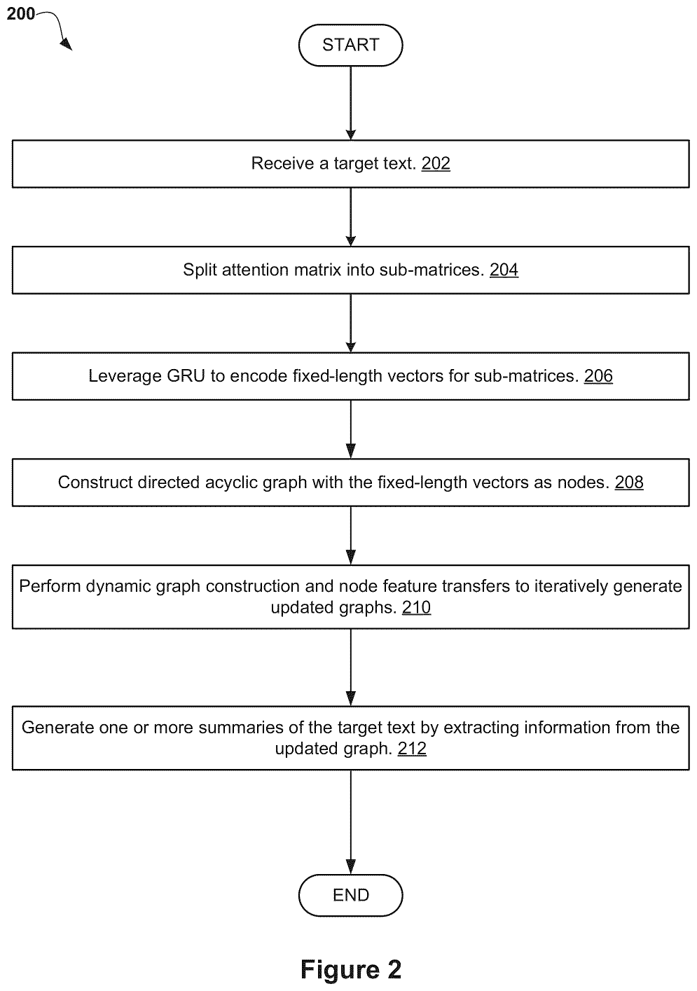

Referring now to FIG. 2, an operational flowchart for an illustrative process 200 of overcoming maximum token limitations in large language models according to at least one embodiment is provided.

At 202, data processing program 150 may receive a target text. In the context of this disclosure, the target text may refer to any natural language text, coding or programming languages, data or structured text, mathematical equations, scientific and technical text, or any other type of desirable target text that may include any number of desired characters or tokens. In some embodiments, the received target text may be contained within any suitable desired format from which text may be extracted using known text extraction techniques. Data processing program 150 is configured to process target texts that include a number of tokens that may exceed the maximum token limit for a target large language model (‘long texts’). For example, in embodiments, data processing program 150 may receive an exemplary target text ‘Tl’ that is 40,000 tokens in length, that is intended to be input into an exemplary target large language model ‘LLM1’ which has a maximum token limit of 32,000.

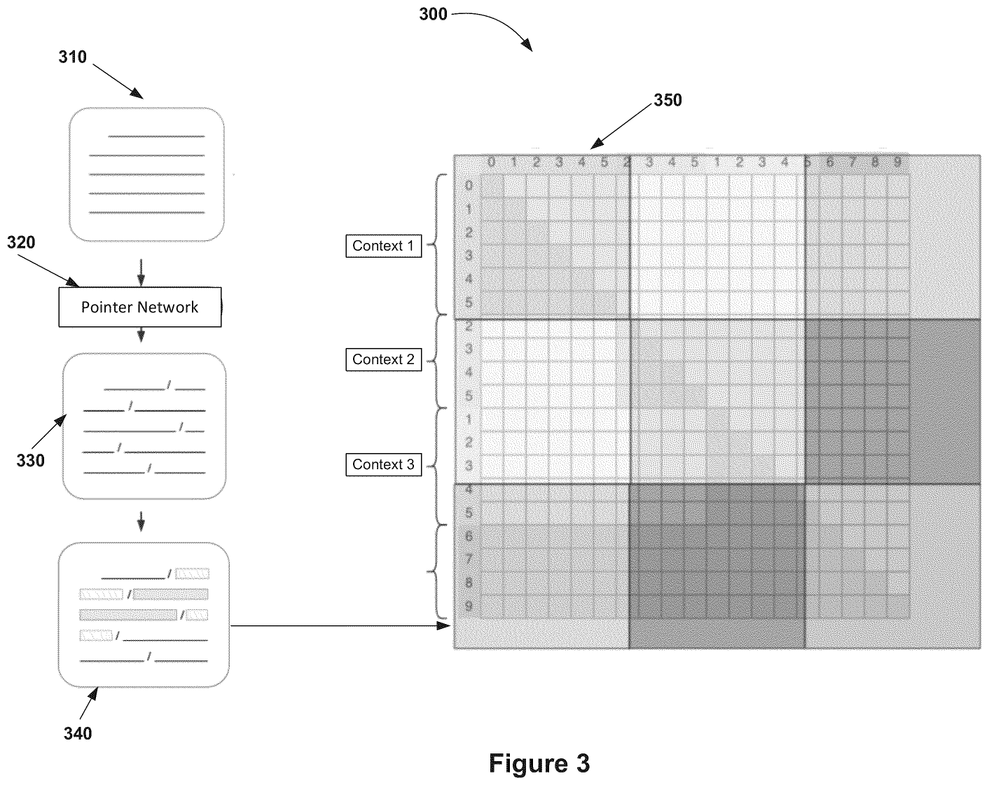

At 204, data processing program 150 may split an attention matrix associated with the target text into a series of sub-matrices. FIG. 3 illustrates an exemplary process of splitting an attention matrix associated with a received target text into a series of sub-matrices according to at least one embodiment. As shown in illustrative process 300 of FIG. 3, at this step, data processing program 150 may feed a received target text 310 into an exemplary pointer network 320 to perform semantic segmentation. The resulting obtained segments of text at 330 are semantically coherent and of shorter length than the original received target text at 310. As shown at 340, the obtained segments of text each correspond to their own context. Data processing program 150 may extract a of N*N submatrix (where N is the length of the context) from the Attention matrix to obtain a series of sub-matrices. The series of sub-matrices are thus also associated with their own unique contexts. This process may then be repeated, decomposing the original Attention matrix into several different submatrices, as shown at 350, where each submatrix represents a semantically independent context. Data processing program 150 may then further process the obtained series of sub-matrices from the split attention matrix.

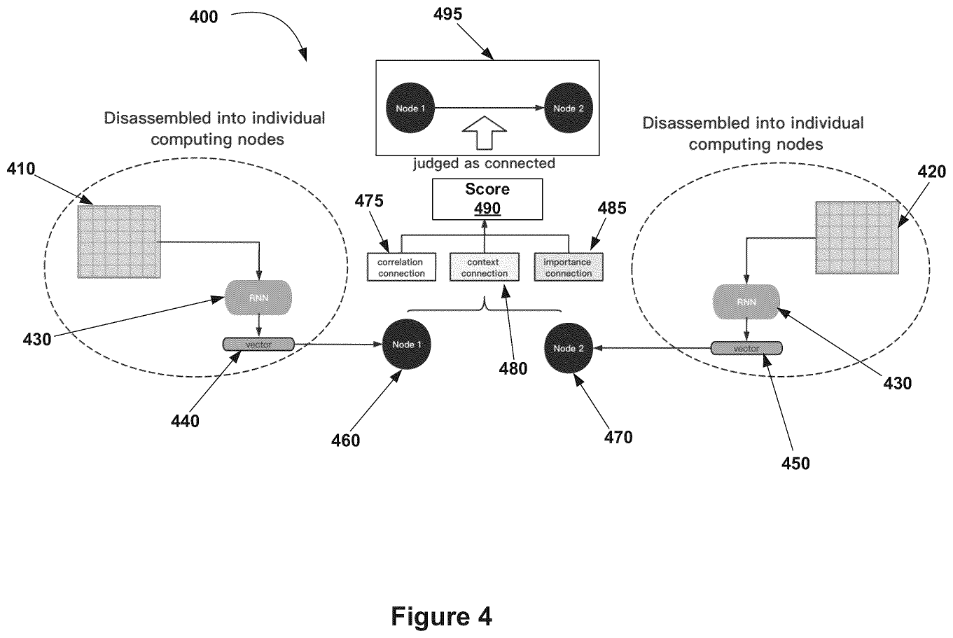

Next, at 206, data processing program 150 may leverage a Gated Recurrent Unit (GRU) neural network to encode fixed-length vectors corresponding to the series of sub-matrices. For example, at this step, data processing program 150 may leverage the sub-matrices 340 shown in FIG. 4 as input features by feeding the series of sub-matrices into a GRU network. The GRU network may, for example, reshape the sub-matrices into a 784-dimensional embedding. In embodiments, any suitable recurrent neural network (RNN) capable of performing the above-described functions may be leveraged to encode fixed-length vectors corresponding to the series of sub-matrices. As shown in FIG. 3, data processing program 150 may, for example, input a first exemplary sub-matrix 350 and a second exemplary sub-matrix 360 into respective RNNs 370 to obtain fixed-length vectors 380 and 390 respectively.

At 208, data processing program 150 may construct a directed acyclic graph in which the encoded fixed-length vectors correspond to nodes, and connections between the nodes are defined based on a target task. FIG. 4 illustrates an exemplary process 400 of constructing directed acyclic graphs according to at least one embodiment. As shown in FIG. 4, and as described above, respective sub-matrices 410 and 420 are fed into RNNs 430 to obtain fixed-length vectors 440 and 450 respectively. At step 208, data processing program 150 may be configured to construct a directed acyclic graph and define nodes therein where each of the encoded fixed-length vectors (such as vectors 440 and 450) serve as nodes 460 and 470 respectively, each representing a computational unit. Then, data processing program 150 may establish connections between nodes based on requirements of a target task and relationships between associated information of interest. For example, in embodiments, data processing program 150 may establish connection between nodes based on relevance connections 475 by connecting nodes based on relevance relationships between submatrices using known similarity measures such as cosine similarity or correlation coefficient can be used to determine the strength of connections between nodes. Nodes corresponding to submatrix encodings with high relevance can have strong connections, indicating a close association of information between them. In embodiments, data processing program 150 may establish further connections between nodes based on context connections at 480. In the context of this disclosure, connections between nodes may be determined based on the contextual relationships within the submatrices. For example, if two submatrices are adjacent or have a logical relationship in the original text, data processing program 150 may establish a connection between them. In embodiments, data processing program 150 may further establish further connections between nodes based on importance connections at 485. In the context of this disclosure, importance connections or importance relationships between nodes may be determined based on the importance or level of focus of the submatrices. For example, if a submatrix contains important information or key viewpoints, nodes connected to the encoding node of that submatrix may have stronger connections. In embodiments, when establishing connections, data processing program 150 may be configured to calculate a comprehensive score at 490 by considering the three connection types discussed above to determine whether two nodes should be connected. The score may be calculated using any suitable known methods. In embodiments, the comprehensive score may be compared to a predetermined and user-adjustable threshold value to control when a connection is established between a pair of nodes being considered, as is shown at 495.

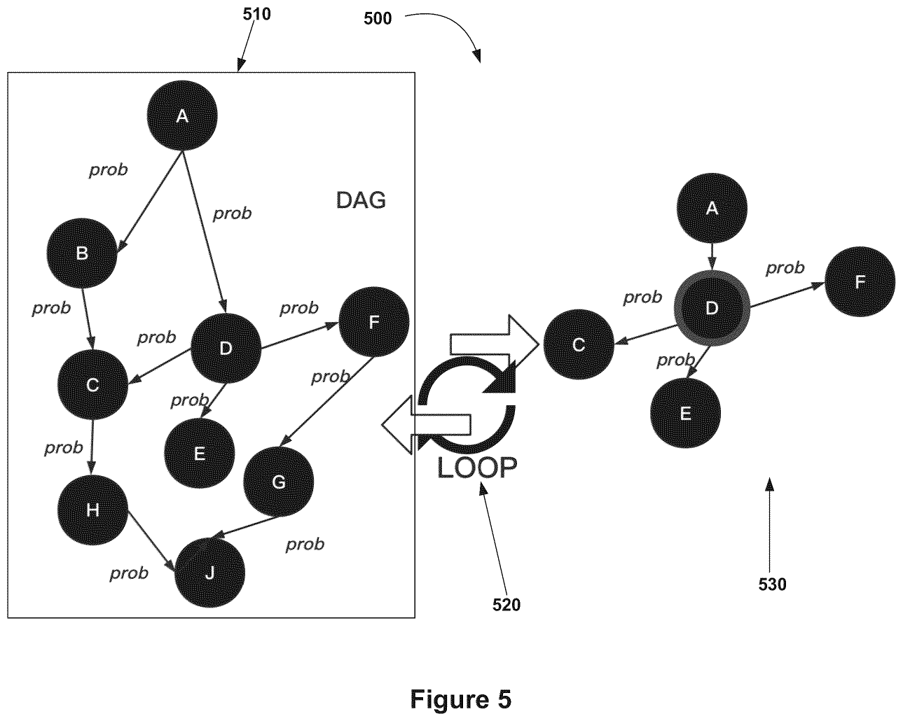

At 210, data processing program 150 may then leverage a graph neural network (GNN) to perform dynamic graph construction and node feature transfers to iteratively generate an updated graph including a series of most relevant node features and connection relationships. At this step, data processing program 150 may leverage GNN models to iteratively facilitate information propagation and updates based on node features and connectivity relationships. In embodiments, data processing program 150 may leverage Graph Convolutional Networks (GCN), GraphSAGE algorithms, Graph Attention Networks (GAT), and any other suitable GNN models or algorithms. An illustrative example of step 210 is depicted within FIG. 5 which includes an illustrative process 500 of leveraging a graph neural network (GNN), specifically a GCN model to perform dynamic graph construction and node feature transfers to iteratively generate an updated graph including a series of most relevant node features and connection relationships according to at least one embodiment. In a first step, data processing program 150 may leverage the GCN to initialize node features, such that each sub-matrix's encoded vector is utilized as the initial feature for each node. Next, data processing program 150 may construct a preliminary directed acyclic graph 510 based on the connectivity relationships between nodes (for example based on probabilities). Thus, preliminary directed acyclic graph 510 describes the strength of connections or relationships between nodes. Next, at Loop 520, data processing program may leverage the GNN to perform GNN layer iteration. In each iteration of the GNN layer, exemplary steps may be employed to update and propagate node features. For example, layer iteration performed at Loop 520 may include aggregating of neighbor features by using preliminary directed acyclic graph 510 to aggregate the features of each node's neighbor nodes. This can be achieved by weighted averaging or splicing operations on neighbor node features. Layer iteration performed at Loop 520 may further include updating node features. For example, the gathered neighbor features may be fused with the features of a given current node to generate new node features. This may be achieved by applying an update function such as a graph convolution operation, a gated recurrent unit (GRU), a graph attention mechanism (GAT), or any other suitable mechanism or model. In embodiments, layer iteration performed at Loop 520 may further include transferring of node features. For example, data processing program 150 may transfer the updated node feature to the next iteration of the GNN layer associated with a next round of feature update. Multiple rounds of iterations may be performed through the multi-layer GNN structure. In each round of GNN iterations, the GNN model updates node features and transfers information based on node features and connection relationships. Thus, leveraging relevant probability relationships ensures that only the nodes that need to be calculated will be calculated, while other nodes can be ignored, reducing the amount of calculation.

In embodiments, data processing program 150 may be configured to include a stop condition, such that according to a specific stop condition, the end of the GNN iteration (performed at Loop 520) may be determined. For example, in embodiments, stopping conditions may be met after reaching a certain number of iterations, after convergence of node features, or any other desired and configurable custom conditions. At 530, an updated graph 530 may be obtained, updated graph 530 including a series of most relevant node features and connection relationships.

Thereafter, at 212, data processing program 150 may generate one or more summaries for the received target text by extracting information from the updated graph. For example, at this step, data processing program 150 may extract information from the updated graph to generate a summary by extracting key sentences based on node features, or by classifying node features. In embodiments, data processing program 150 may generate other desired outputs at this step such as recommendations or any other output generatable based on the extracted information from the updated graph to limit or reduce the amount of tokens associated with the received target text that may ultimately be input into a given large language model.

It may be appreciated that data processing program 150 has thus provided improved methods of overcoming maximum token limitations in large language models that overcome challenges observed in conventional and known methods to overcome maximum token limits in large language models.

For example, as discussed above, described embodiments reduce global computational complexity. In traditional attention mechanisms, each token requires calculating attention scores with all other tokens, leading to a significant increase in computational complexity as the number of tokens grows. In described embodiments, by splitting the Attention matrix, global attention computation is transformed into calculations between local sub-matrices, greatly reducing the computational load.

Furthermore, presently described embodiments provide for the benefit of establishing local relationships. By splitting the original Attention matrix into multiple sub-matrices and using a DAG to construct connections, local semantic relationships can be captured. This enables the localization of important information, avoiding the processing of the entire text as a continuous sequence, thus reducing the processing of irrelevant information while maintaining task relevance.

Presently described embodiments also allow for dynamic computation of nodes. In the constructed DAG, the computation of each node is dynamic, unlike traditional methods that require computing the entire Attention matrix. Based on the probabilistic relationships between nodes, only the nodes that need to be computed are evaluated, while others can be ignored. This further reduces the computational load, focusing only on nodes that are meaningful for a given current task and context.

It may be further appreciated that the described embodiments uniquely combine Naive Bayes with GRU (Gated Recurrent Unit) to address the issue of rapidly expanding token quantities. The GRU can group encode the subsequences of tokens, enabling the calculation of attention matrices, and then transform the grouped calculation units into a directed acyclic graph (DAG) using the Naive Bayes algorithm. Each node on the DAG represents a computation unit, and whether each computation unit needs to be computed is dynamic, as opposed to the previous method where all units must be computed. The DAG decomposes the calculation process of the attention matrix into several parts, with each part corresponding to a node on the DAG. During the construction of the DAG, no computation units are executed, meaning that the computation of the DAG is “lazy,” and each computation unit is only computed when it needs to be. Thus, whether a computation node is computed or not depends on the probability relationship between the previous computed node and the current node, which is also calculated using the Naive Bayes method.

Thus, described methods of splitting the Attention matrix and constructing DAGs achieves effective processing of long texts and information saving by reducing global computational complexity, establishing local relationships, and dynamically computing nodes. This approach fully utilizes local correlations and task relevance, enabling the model to handle long texts more efficiently and avoiding information loss during processing of ‘long’ texts that exceed a given maximum token limit for a target large language model.

Presently described embodiments may relate to the following clauses:

Clause 1: A computer-based method for overcoming maximum token limitations in large language models, the method including: receiving a target text, splitting an attention matrix associated with the target text into a series of sub-matrices, leveraging a Gated Recurrent Unit (GRU) neural network to encode fixed-length vectors corresponding to the series of sub-matrices, constructing a directed acyclic graph in which the encoded fixed-length vectors include nodes and wherein connections between the nodes are defined based on a target task, leveraging a graph neural network (GNN) to perform dynamic graph construction and node feature transfers to iteratively generate an updated graph including a series of most relevant node features and connection relationships, and generating one or more summaries for the received target text by extracting information from the updated graph. This allows described embodiments to functionally combine Naive Bayes methods with leveraging of gated recurrent unit neural networks as long-term memory storage to overcome the maximum token limit imposed by a given large language model. This improves the versatility of the large language models employing described embodiments as a result of described embodiments leveraging gated recurrent unit neural networks to group encode subsequences of tokens in received target texts, enabling the calculation of attention matrices, and subsequent transformation of the grouped calculation units into a directed acyclic graph (DAG) using a Naïve Bayes algorithm.

Clause 2: The computer-based method of clause 1, where the received target text includes a number of tokens exceeding a maximum token limit associated with a target large language model. In such embodiments, the received target text would not be processable by the target large language model until steps are performed in accordance with described embodiments. Accordingly, the received text including a number of tokens exceeding the maximum token limit provides for additional inputs that may be processed by the target large language model while further functionally enabling the performance of described methods to overcome maximum token limits.

Clause 3: The computer-based method of any of the preceding clauses 1-2, where each submatrix in the series of sub-matrices represents a semantically independent context. This ensures that any subsequently generated representations associated with portions of the target text still correspond to relevant context which may be leveraged during subsequent steps to ensure that the meaning and features of the target text are maintained.

Clause 4: The computer-based method of any of the preceding clauses 1-3, where the connections between the nodes are determined using at least one of relevance relationships between the submatrices based on similarity measures, context relationships based on logical associations between the submatrices, and important relationships based on focus levels of the submatrices. In embodiments, the determined relevance relationships ensure that nodes corresponding to submatrix encodings with high relevance will have strong connections, indicating a close association of information between them. This determination is then leveraged to determine whether nodes should be connected within a directed acyclic graph based on associated scoring steps.

Clause 5: The computer-based method of any of the preceding clauses 1-4, where the target task includes at least one of classification, summary generation, and recommendation. This provides versatility for the target large language model employing described embodiments, as the target tasks performed may include a variety of useful tasks that are each uniquely valuable, but leverage the same data and features made available using described embodiments to overcome maximum token limits associated with the target large language model which is tasked with processing the received long text.

Clause 6: The computer-based method of any of the preceding clauses 1-5, where leveraging the graph neural network to perform the dynamic graph construction and the node feature transfers to iteratively generate the updated graph including the series of most relevant node features and the connection relationships further includes: defining a preliminary directed acyclic graph, and, for each of a series of nodes in the defined preliminary directed acyclic graph, aggregating features of neighbor nodes by weighted averaging or splicing operations on neighbor node features. In such embodiments, each round of GNN iterations, the GNN model updates node features and transfers information based on node features and connection relationships. Thus, leveraging relevant probability relationships ensures that only the nodes that need to be calculated will be calculated, while other nodes can be ignored, reducing the amount of calculation, and thereby improving the efficiency and performance of the target large language model employing described embodiments to process received texts that exceed a given maximum token limit.

Clause 7: The computer-based method of any of the preceding clauses 1-6, where the method further includes: applying an update function to fuse gathered neighbor features with a series of current features for a target node generate updated node features; and transferring the generated updated node features to a next iteration of a GNN layer. This similarly functions to reduce the amount of calculation, thereby improving the efficiency and performance of the target large language model employing described embodiments to process received texts that exceed a given maximum token limit.

Clause 8: A computer system, the computer system including: one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method including: receiving a target text, splitting an attention matrix associated with the target text into a series of sub-matrices, leveraging a Gated Recurrent Unit (GRU) neural network to encode fixed-length vectors corresponding to the series of sub-matrices, constructing a directed acyclic graph in which the encoded fixed-length vectors comprise nodes and wherein connections between the nodes are defined based on a target task, leveraging a graph neural network (GNN) to perform dynamic graph construction and node feature transfers to iteratively generate an updated graph including a series of most relevant node features and connection relationships, and generating one or more summaries for the received target text by extracting information from the updated graph. This allows described embodiments to functionally combine Naive Bayes methods with leveraging of gated recurrent unit neural networks as long-term memory storage to overcome the maximum token limit imposed by a given large language model. This improves the versatility of the large language models employing described embodiments as a result of described embodiments leveraging gated recurrent unit neural networks to group encode subsequences of tokens in received target texts, enabling the calculation of attention matrices, and subsequent transformation of the grouped calculation units into a directed acyclic graph (DAG) using a Naïve Bayes algorithm.

Clause 9: The computer system of clause 8, where the received target text includes a number of tokens exceeding a maximum token limit associated with a target large language model. In such embodiments, the received target text would not be processable by the target large language model until steps are performed in accordance with described embodiments. Accordingly, the received text including a number of tokens exceeding the maximum token limit provides for additional inputs that may be processed by the target large language model while further functionally enabling the performance of described methods to overcome maximum token limits.

Clause 10: The computer system of any of the preceding clauses 8-9, where each submatrix in the series of sub-matrices represents a semantically independent context. This ensures that any subsequently generated representations associated with portions of the target text still correspond to relevant context which may be leveraged during subsequent steps to ensure that the meaning and features of the target text are maintained.

Clause 11: The computer system of any of the preceding clauses 8-10, where the connections between the nodes are determined using at least one of relevance relationships between the submatrices based on similarity measures, context relationships based on logical associations between the submatrices, and important relationships based on focus levels of the submatrices. In embodiments, the determined relevance relationships ensure that nodes corresponding to submatrix encodings with high relevance will have strong connections, indicating a close association of information between them. This determination is then leveraged to determine whether nodes should be connected within a directed acyclic graph based on associated scoring steps.

Clause 12: The computer system of any of the preceding clauses 8-11, where the target task includes at least one of classification, summary generation, and recommendation. This provides versatility for the target large language model employing described embodiments, as the target tasks performed may include a variety of useful tasks that are each uniquely valuable, but leverage the same data and features made available using described embodiments to overcome maximum token limits associated with the target large language model which is tasked with processing the received long text.

Clause 13: The computer system of any of the preceding clauses 8-12, where leveraging the graph neural network to perform the dynamic graph construction and the node feature transfers to iteratively generate the updated graph including the series of most relevant node features and the connection relationships further includes: defining a preliminary directed acyclic graph, and, for each of a series of nodes in the defined preliminary directed acyclic graph, aggregating features of neighbor nodes by weighted averaging or splicing operations on neighbor node features. In such embodiments, each round of GNN iterations, the GNN model updates node features and transfers information based on node features and connection relationships. Thus, leveraging relevant probability relationships ensures that only the nodes that need to be calculated will be calculated, while other nodes can be ignored, reducing the amount of calculation, and thereby improving the efficiency and performance of the target large language model employing described embodiments to process received texts that exceed a given maximum token limit.

Clause 14: The computer system of any of the preceding clauses 8-13, where the performed method further includes: applying an update function to fuse gathered neighbor features with a series of current features for a target node generate updated node features; and transferring the generated updated node features to a next iteration of a GNN layer. This similarly functions to reduce the amount of calculation, thereby improving the efficiency and performance of the target large language model employing described embodiments to process received texts that exceed a given maximum token limit

Clause 15: A computer program product, the computer program product including one or more computer-readable tangible storage medium and program instructions stored on at least one of the one or more computer-readable tangible storage medium, the program instructions executable by a processor capable of performing a method, the method including: receiving a target text, splitting an attention matrix associated with the target text into a series of sub-matrices, leveraging a Gated Recurrent Unit (GRU) neural network to encode fixed-length vectors corresponding to the series of sub-matrices, constructing a directed acyclic graph in which the encoded fixed-length vectors comprise nodes and wherein connections between the nodes are defined based on a target task, leveraging a graph neural network (GNN) to perform dynamic graph construction and node feature transfers to iteratively generate an updated graph including a series of most relevant node features and connection relationships, and generating one or more summaries for the received target text by extracting information from the updated graph.

Clause 16: The computer program product of clause 15, where the received target text includes a number of tokens exceeding a maximum token limit associated with a target large language model. In such embodiments, the received target text would not be processable by the target large language model until steps are performed in accordance with described embodiments. Accordingly, the received text including a number of tokens exceeding the maximum token limit provides for additional inputs that may be processed by the target large language model while further functionally enabling the performance of described methods to overcome maximum token limits.

Clause 17: The computer program product of any of the preceding clauses 15-16, where each submatrix in the series of sub-matrices represents a semantically independent context. This ensures that any subsequently generated representations associated with portions of the target text still correspond to relevant context which may be leveraged during subsequent steps to ensure that the meaning and features of the target text are maintained.

Clause 18: The computer program product of any of the preceding clauses 15-17, where the connections between the nodes are determined using at least one of relevance relationships between the submatrices based on similarity measures, context relationships based on logical associations between the submatrices, and important relationships based on focus levels of the submatrices. In embodiments, the determined relevance relationships ensure that nodes corresponding to submatrix encodings with high relevance will have strong connections, indicating a close association of information between them. This determination is then leveraged to determine whether nodes should be connected within a directed acyclic graph based on associated scoring steps.

Clause 19: The computer program product of any of the preceding clauses 15-18, where the target task includes at least one of classification, summary generation, and recommendation. This provides versatility for the target large language model employing described embodiments, as the target tasks performed may include a variety of useful tasks that are each uniquely valuable, but leverage the same data and features made available using described embodiments to overcome maximum token limits associated with the target large language model which is tasked with processing the received long text.

Clause 20: The computer program product of any of the preceding clauses 15-19, where leveraging the graph neural network to perform the dynamic graph construction and the node feature transfers to iteratively generate the updated graph including the series of most relevant node features and the connection relationships further includes: defining a preliminary directed acyclic graph, and, for each of a series of nodes in the defined preliminary directed acyclic graph, aggregating features of neighbor nodes by weighted averaging or splicing operations on neighbor node features. In such embodiments, each round of GNN iterations, the GNN model updates node features and transfers information based on node features and connection relationships. Thus, leveraging relevant probability relationships ensures that only the nodes that need to be calculated will be calculated, while other nodes can be ignored, reducing the amount of calculation, and thereby improving the efficiency and performance of the target large language model employing described embodiments to process received texts that exceed a given maximum token limit.

It may be appreciated that FIGS. 2-5 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of overcoming maximum token limitations in large language models, the method comprising:
receiving a target text;
splitting an attention matrix associated with the target text into a series of sub-matrices;
leveraging a Gated Recurrent Unit (GRU) neural network to encode fixed-length vectors corresponding to the series of sub-matrices;
constructing a directed acyclic graph in which the encoded fixed-length vectors comprise nodes and wherein connections between the nodes are defined based on a target task;
leveraging a graph neural network (GNN) to perform dynamic graph construction and node feature transfers to iteratively generate an updated graph including a series of most relevant node features and connection relationships; and
generating one or more summaries for the received target text by extracting information from the updated graph.

2. The computer-based method of claim 1, wherein the received target text includes a number of tokens exceeding a maximum token limit associated with a target large language model.

3. The computer-based method of claim 1, wherein each submatrix in the series of sub-matrices represents a semantically independent context.

4. The computer-based method of claim 1, wherein the connections between the nodes are determined using at least one of relevance relationships between the submatrices based on similarity measures, context relationships based on logical associations between the submatrices, and important relationships based on focus levels of the submatrices.

5. The computer-based method of claim 1, wherein the target task comprises at least one of classification, summary generation, and recommendation.

6. The computer-based method of claim 1, wherein leveraging the graph neural network to perform the dynamic graph construction and the node feature transfers to iteratively generate the updated graph including the series of most relevant node features and the connection relationships further comprises:
defining a preliminary directed acyclic graph; and
for each of a series of nodes in the defined preliminary directed acyclic graph, aggregating features of neighbor nodes by weighted averaging or splicing operations on neighbor node features.

7. The computer-based method of claim 6, further comprising:
applying an update function to fuse gathered neighbor features with a series of current features for a target node generate updated node features; and
transferring the generated updated node features to a next iteration of a GNN layer.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a target text;
splitting an attention matrix associated with the target text into a series of sub-matrices;
leveraging a Gated Recurrent Unit (GRU) neural network to encode fixed-length vectors corresponding to the series of sub-matrices;
constructing a directed acyclic graph in which the encoded fixed-length vectors comprise nodes and wherein connections between the nodes are defined based on a target task;
leveraging a graph neural network (GNN) to perform dynamic graph construction and node feature transfers to iteratively generate an updated graph including a series of most relevant node features and connection relationships; and
generating one or more summaries for the received target text by extracting information from the updated graph.

9. The computer system of claim 8, wherein the received target text includes a number of tokens exceeding a maximum token limit associated with a target large language model.

10. The computer system of claim 8, wherein each submatrix in the series of sub-matrices represents a semantically independent context.

11. The computer system of claim 8, wherein the connections between the nodes are determined using at least one of relevance relationships between the submatrices based on similarity measures, context relationships based on logical associations between the submatrices, and important relationships based on focus levels of the submatrices.

12. The computer system of claim 8, wherein the target task comprises at least one of classification, summary generation, and recommendation.

13. The computer system of claim 8, wherein leveraging the graph neural network to perform the dynamic graph construction and the node feature transfers to iteratively generate the updated graph including the series of most relevant node features and the connection relationships further comprises:
defining a preliminary directed acyclic graph; and
for each of a series of nodes in the defined preliminary directed acyclic graph, aggregating features of neighbor nodes by weighted averaging or splicing operations on neighbor node features.

14. The computer system of claim 13, further comprising:
applying an update function to fuse gathered neighbor features with a series of current features for a target node generate updated node features; and
transferring the generated updated node features to a next iteration of a GNN layer.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a target text;
splitting an attention matrix associated with the target text into a series of sub-matrices;
leveraging a Gated Recurrent Unit (GRU) neural network to encode fixed-length vectors corresponding to the series of sub-matrices;
constructing a directed acyclic graph in which the encoded fixed-length vectors comprise nodes and wherein connections between the nodes are defined based on a target task;
leveraging a graph neural network (GNN) to perform dynamic graph construction and node feature transfers to iteratively generate an updated graph including a series of most relevant node features and connection relationships; and
generating one or more summaries for the received target text by extracting information from the updated graph.

16. The computer program product of claim 15, wherein the received target text includes a number of tokens exceeding a maximum token limit associated with a target large language model.

17. The computer program product of claim 15, wherein each submatrix in the series of sub-matrices represents a semantically independent context.

18. The computer program product of claim 15, wherein the connections between the nodes are determined using at least one of relevance relationships between the submatrices based on similarity measures, context relationships based on logical associations between the submatrices, and important relationships based on focus levels of the submatrices.

19. The computer program product of claim 15, wherein the target task comprises at least one of classification, summary generation, and recommendation.

20. The computer program product of claim 15, wherein leveraging the graph neural network to perform the dynamic graph construction and the node feature transfers to iteratively generate the updated graph including the series of most relevant node features and the connection relationships further comprises:
defining a preliminary directed acyclic graph; and
for each of a series of nodes in the defined preliminary directed acyclic graph, aggregating features of neighbor nodes by weighted averaging or splicing operations on neighbor node features.
